(19) United States
(12) Patent Application Publication
(10) Pub. No.: US 2009/0138974 A1
(43) Pub. Date: May 28, 2009

(54) CONTROLLED ACCESS TO MEDIA CONTENT

(75) Inventors: Jorge L. Perdomo, Boca Raton, FL (US); Daniel A. Baudino, Lake Worth, FL (US)

Correspondence Address: CUENOT & FORSYTHE, L.L.C., 12230 FOREST HILL BLVD., SUITE 120, WELLINGTON, FL, 33414, US

(73) Assignee: MOTOROLA, INC., Schaumburg, IL (US)

(21) Appl. No.: 11/946,820

(22) Filed: Nov. 28, 2007

(51) Int. Cl. G06F 21/00

(52) U.S. Cl. 726/28

(57) ABSTRACT

A method (300, 400) of providing selective access to media content (224). The method can include, for at least one user, receiving an access certificate (114) that authorizes the user to access the media content based on the user's presence in a particular zone (110) at a particular time. Further, a determination can be made whether the user is authorized to access the media content. The user can be provided access to the media content when the user is authorized to access the media content. The user can be declined access to the media content when the user is not authorized to access the media content.

### BACKGROUND OF THE INVENTION

1. Field of the Invention

The present invention generally relates to web logs and, more particularly, to controlling access to a web log.

2. Background of the Invention

The use of web logs, also known as blogs, has grown in popularity in recent years. Many web logs provide commentary or news on a particular subject, while others function as personal online diaries. A typical web log combines text, images, and links to other web logs, web pages, and media content. Many web logs also provide the opportunity for readers to leave comments in an interactive format.

Oftentimes web logs are available over the Internet to anyone wishing to visit, although some web logs require users to complete a web log subscription form. If it is desired to ensure that a web log be available only to those in a particular user group, a comprehensive user list may need to be manually compiled and maintained. This can be a time consuming and difficult task, especially if there are a large number of participants in the user group or the participants in the user group change frequently.

### SUMMARY OF THE INVENTION

The present invention relates to a method of providing selective access to media content. The method can include, for at least one user, receiving an access certificate that authorizes the user to access the media content based on the user's presence in a particular zone at a particular time. The access certificate also can be based on the user's participation in a particular event. In one arrangement, the access certificate can indicate a particular level of access to the media content that is granted to the user.

A determination can be made whether the user is authorized to access the media content. The user can be provided access to the media content when the user is authorized to access the media content. The user can be declined access to the media content when the user is not authorized to access the media content.

The method further can include monitoring the user's presence within the zone and authorizing the user to receive the media content only if the user visits the zone at a minimum frequency and/or if the user visits the zone for a minimum amount of time. The user's presence in the zone can be identified with a positioning system or based on an access point with which the communication device has established a communication link.

The method also can include automatically communicating the access certificate to the communication device or communicating the access certificate to the communication device in response to receiving a user request from the communication device.

The present invention also relates to a method of providing selective access to media content that includes identifying at least one communication device within a particular zone and communicating an access certificate to the communication device. The access certificate can indicate the particular zone. Further, an authorization to access the media content can be provided. Communicating the access certificate can include communicating an access certificate that indicates a user's presence in the zone. Further, communicating the access certificate can include communicating an access certificate that indicates a user's presence in the zone at a particular time, a user's participation in a particular event, and/or a particular level of access to the media content that is granted to the user.

The present invention also relates to a program storage device readable by a machine, tangibly embodying a program of instructions executable by the machine to perform the various steps and/or functions described herein.

### BRIEF DESCRIPTION OF THE DRAWINGS

Preferred embodiments of the present invention will be described below in more detail, with reference to the accompanying drawings, in which:

FIG. 1 depicts a communication system that is useful for understanding the present invention;

FIG. 2 depicts another communication system that is useful for understanding the present invention;

FIG. 3 depicts a flowchart illustrating a method that is useful for understanding the present invention; and

FIG. 4 depicts another flowchart illustrating a method that is useful for understanding the present invention.

### DETAILED DESCRIPTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

In accordance with the arrangements described herein, access to media can be limited to users associated with a particular zone. Such users can be authorized to access the media content based on their current presence within the zone, or their presence within the zone at a particular time. For instance, access to the media content can be limited to users who are currently located within the zone, or users who were located in the zone at the time of a particular event.

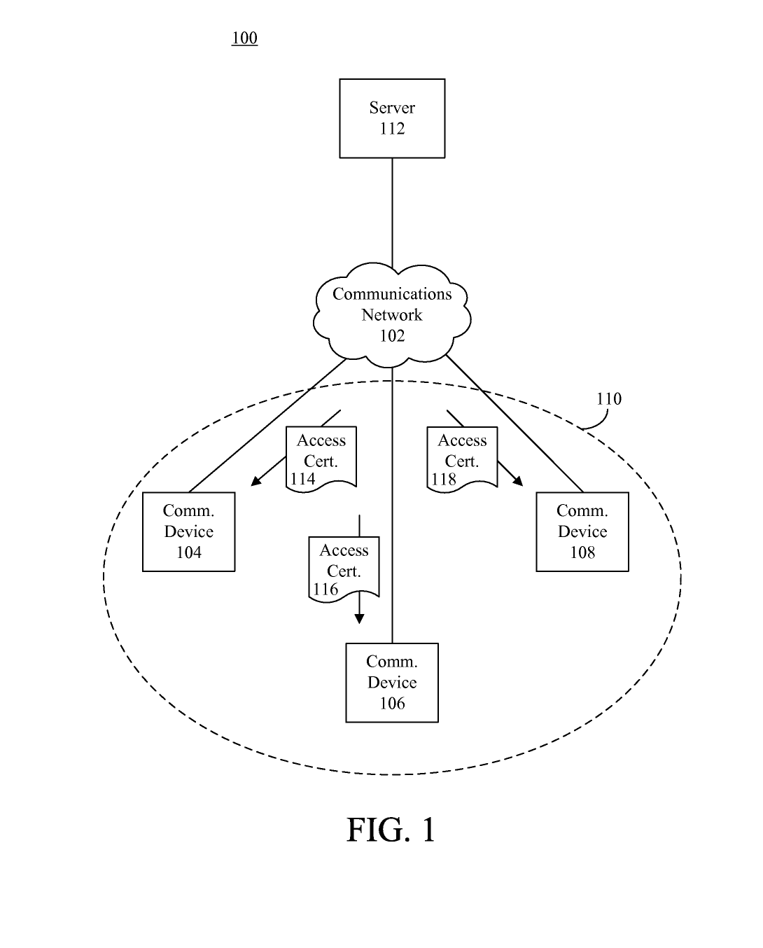

FIG. 1 depicts a communication system 100 that is useful for understanding the present invention. The communication system 100 can include a communications network 102. The communications network 102 can be implemented in accordance with any suitable communications standards, protocols, and/or architectures, or a suitable combination of such standards, protocols, and/or architectures. For example, the communications network 102 can comprise the Internet, the World Wide Web, a wide area network (WAN), a local area network (LAN), a cellular communications network, a public switched telephone network (PSTN), and/or any other networks or systems over which communication signals can be propagated. In that regard, the communications network 102 can include wired and/or wireless communication links.

The communication system 100 also can include one or more communication devices 104, 106, 108 located within a zone 110. The communication devices 104-108 can be, for instance, mobile stations (e.g. mobile telephones, mobile radios, mobile computers, personal digital assistants, or the like), computers, gaming devices, or any other devices suitably configured to communicate via the communications network 102. As such, the communication devices 104-108 can comprise one or more processors/controllers, transceivers, network adapters, and/or other suitable components.

As used herein, the term “zone” means a geographic area that is distinguished from other geographic areas. For example, the zone 110 can be an area in which a school, a university, a shopping center or an amusement park is located. In other examples, the zone 110 can include a building or group of buildings, an entertainment facility, a park, a housing development, a village, a city, and the like. The zone 110 can be defined by network infrastructure (e.g. one or more access points), global or local positioning coordinates, or in any other suitable manner.

The communication system 100 further can include a server 112. The server 112 also can comprise one or more processors/controllers, transceivers, network adapters, and/or other suitable components. The server 112 can be located within the zone 110 or located outside the zone 110.

In operation, the server 112 can detect that the communication devices 104-108 are present within the zone 110. Such detection can be performed in any suitable manner. For example, in response to a communication device 104 establishing network presence on the communications network 102, the server 110 can receive an indicator that indicates an access point with which the communication device 104 has established a communication link. If such access point is located within the zone 110, the indicator can indicate that the communication device 104 is present within the zone 110.

In another arrangement, a local positioning system or global positioning system (GPS) can indicate the present location of the communication device 104, and corresponding positioning information can be communicated to the server 112. For example, if the communication device 104 includes a GPS, the communication device 104 can communicate the position information to the server 112. If a local positioning system is implemented, the local positioning system or the communication device 104 can communicate the position information to the server 112.

In response to identifying the communication devices 104-108 are present within the zone 110, the server 112 can authorize the communication devices 104-108 to access media content that is exclusive to communication devices present in the zone 110. Optionally, such authorization may be limited to communication devices whose users are participants in a particular event or events. The media content can include, but is not limited to text, images, audio, video, and hyperlinks. For example, the media content can comprise a live audio/video data stream. The media content can be accessed, for example, from a web log contained on a web site or a web portal. Optionally, a user also may post media content to the web log or web portal.

In one arrangement, the server 112 can receive identifiers for the respective communication devices 104-108, and associate such identifiers with times (e.g. times of day, days and/or dates) that the respective communication devices 104-108 are present within the zone 110. The identifiers can be, for example, media access control (MAC) addresses and/or IP addresses assigned to the respective communication devices 104-108. Further, the server 112 also can maintain data pertaining to the frequency and particular instances of the respective communication devices 104-108 being within the zone 110.

In another arrangement, the server 112 can communicate access certificates 114, 116, 118 to the respective communication devices 104-108. As used herein, the term “access certificate” means a code or file that can be stored on a communication device 104, and communicated from the communication device 104 to another device to gain access to the media content. As used herein, “access media content” means to view, edit, download and/or upload the media content. The access certificates 114-118 can comprise a particular code, an indicator of a time in which a communication device 104-108 is present in the zone 110. The access certificates 114-118 can be communicated to the respective communication devices 104-108 automatically, or response to receiving user requests from the communication devices 104-108.

In one arrangement, each of the access certificates 114-118 can provide an equivalent level of access to media content. In another arrangement, the access certificates 114-118 can grant different levels of access to the media content. Such levels can depend, for instance, on user associations with various user groups. For example, the access certificate 114 may indicate a level of access that grants a user the ability to view, edit, upload and download media content, and the access certificate 116 may indicate a level of access that grants to the user only the ability to view and download media content. In a further example, the access certificate may indicate a level of access that grants to a user only the ability to access the media content while the user is located within the zone 110.

The access certificates 114-118 may be used exclusively by the respective communication devices 104-108 to which the access certificates 114-118 are communicated. For example, the access certificates 114-118 can be associated with a MAC address or an IP address. Further, each of the access certificates 114-118 can be associated with a user name, a user account identifier and/or a pass code (e.g. password or personal identification number). In such an arrangement, the user name, user account identifier and/or password, along with a corresponding certificate 114, may be required to access media content. Use of the access certificates 114-118 also can be dynamic. For instance, the access certificates 114-118 can be transferred to, and used by, other users and/or other communication devices (not shown) to gain access to the media content.

In yet another arrangement, in response to identifying the communication devices 104-108 are present within the zone 110, the server 112 can invite users of the communication devices 104-108 to register with the server 112. For example, the server 112 can prompt the users to enter user names and passwords. The server 112 can store such information in a suitable data file or data table. In such an arrangement, a user can present a user name and corresponding password at a later time to gain access to the media content.

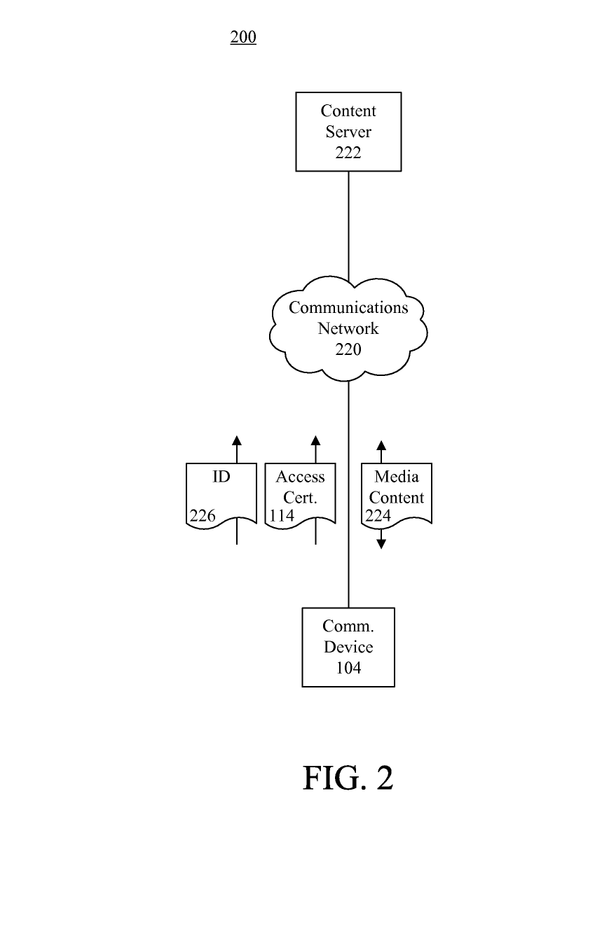

FIG. 2 depicts another communication system 200 that is useful for understanding the present invention. The communication system 200 can include a communications network 220, which can be the communications network 102 described in FIG. 1 or another communications network. In that regard, the communications network 220 can be implemented in accordance with any suitable communications standards, protocols, and/or architectures, or a suitable combination of such standards, protocols, and/or architectures. Further, the communications network 220 can include wired and/or wireless communication links.

The communication system 200 also can include a content server 222. The content server 222 can provide media content 224 via the communications network 220. In one arrangement, the content server 222 can be the server 112 of FIG. 1, though this need not be the case.

As noted, the media content 224 can comprise text, image, audio and/or video content. In one aspect of the inventive arrangements, the content server 222 can provide the media content 224 to communication devices in response to determining that the communication devices are authorized to receive such media content 224. For example, the content server 222 can provide the media content 224 to the communication device 104, or receive media content from the communication device 104, when the communication device 104 is within the zone. In another aspect of the inventive arrangements, the content server 222 also can provide and receive media content 224 when the communication device is located outside the zone.

The content server 222 also can provide the media content 224 to the communication device 104 in response to receiving a suitable identifier 226 (e.g. a MAC address, IP address, user name and/or a password) from the communication device 104. In such an arrangement, the content server 222 can select media content 224 that corresponds to the identifier 226, for instance media content that corresponds to a time with which the identifier 226 is associated. The content server 222 also can receive media content 224 from the communication device 104 and associate such media content with the time with which the identifier 226 is associated.

In another aspect of the inventive arrangements, the content server 222 can provide/receive the media content 224 to/from the communication device 104 in response to receiving the access certificate 114 from the communication device 104. As noted, a user name, a user account identifier and/or a pass code also may be required. For instance, the access certificate 114 can indicate a time in which the communication device 104 was present in a particular zone, and the content server 222 can provide/receive media content 224 that correspond to the time. By way of example, within an amusement park, media content can be generated each day and the access certificate 114 can indicate a particular day a user was present in the amusement park. In such an arrangement, the media content 224 can be associated with a particular day, and the media content 224 can comprise media content generated within the amusement park on the identified day.

The content server 222 also can process other parameters to determine whether to provide the media content 224 to the communication device 104. For example, a server can monitor a user's presence within the zone and authorize the user (e.g. via the communication device 104) to receive media content 224 from and/or communicate the media content 224 to the content server 222 only if it is determined that the user visits the zone on a regular basis (e.g. at a minimum frequency) or for a minimum amount of time (e.g. within a particular time period). Such determination can be based on, for instance, a data table or data file that tracks the frequency and/or duration of a user's presence within the zone. Further, as noted, the level access to the media content 224 that is granted can be based on a level of authorization associated with a particular user and/or the access certificate 114.

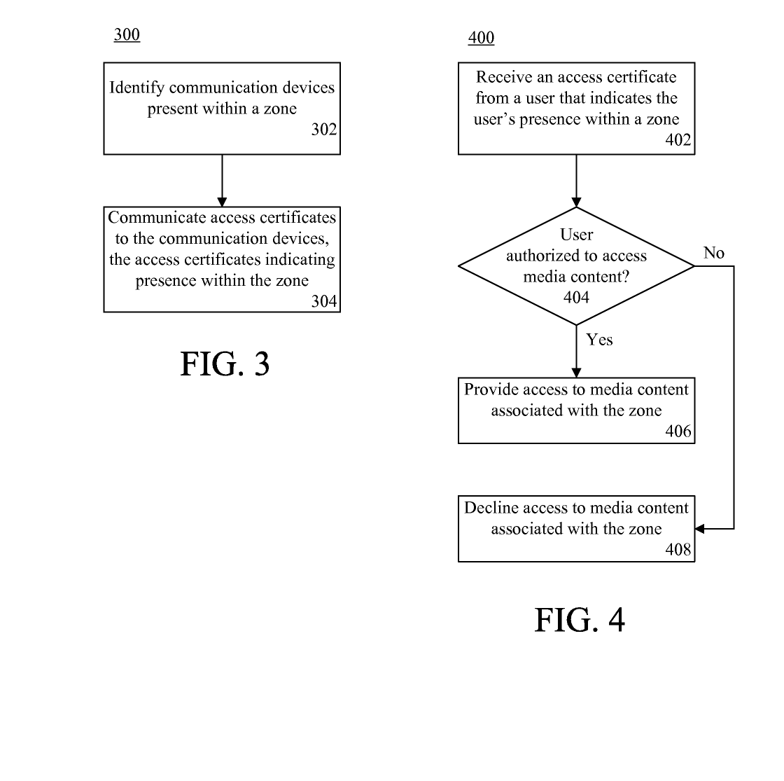

FIG. 3 depicts a flowchart illustrating a method 300 that is useful for understanding the present invention. The method can be implemented by a server or another suitable device. At step 302, communication devices present within a zone can be identified. As noted, such communication devices can be identified using global positioning systems, local positioning systems, or based on access points with which the communication devices have established communication links. At step 304, access certificates can be communicated to the communication devices. As noted, the access certificates can indicate presence in a particular zone. The access certificates also can indicate times (e.g. time of day, day and/or date) of such presence.

FIG. 4 depicts another flowchart illustrating a method 400 that is useful for understanding the present invention. The method 400 also can be implemented by a server or another suitable device. At step 402, an access certificate can be received from a user, for example via a communication device associated with the user. The access certificate can indicate the user's presence within a zone. For example, the access certificate can indicate that the user is currently present within the zone, or can indicate a time in which the user was present within the zone.

Referring to decision box 404, a determination can be made as to whether the user is authorized to access media content. Such determination can be based on the access certificate. If the user is authorized to access media content, at step 406 media content associated with the zone can be provided to the user. As noted, such media content can be limited to media content associated with a particular time in which the user was present in the zone. If the user is not authorized to access the media content, at step 408 access to the media content can be declined.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The present invention can be realized in hardware, software, or a combination of hardware and software. The present invention can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with an application that, when being loaded and executed, controls the processing system such that it carries out the methods described herein. The present invention also can be embedded in a program storage device readable by a machine, tangibly embodying a program of instructions executable by the machine to perform methods and processes described herein. The present invention also can be embedded in an application product which comprises all the features enabling the implementation of the methods described herein and, which when loaded in a processing system, is able to carry out these methods.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a script, a subroutine, a function, a procedure, an object method, an object implementation, an executable application, an applet, a servlet, a MIDlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language).

This invention can be embodied in other forms without departing from the spirit or essential attributes thereof. Accordingly, reference should be made to the following claims, rather than to the foregoing specification, as indicating the scope of the invention.

What is claimed is:

1. A method of providing selective access to media content, comprising:
for at least one user, receiving an access certificate that authorizes the user to access the media content based on the user's presence in a particular zone at a particular time;
determining whether the user is authorized to access the media content; and
providing to the user access to the media content when the user is authorized to access the media content.

2. The method of claim 1, further comprising:
declining to the user access to the media content when the user is not authorized to access the media content.

3. The method of claim 1, wherein receiving the access certificate that authorizes the user to access the media content comprises receiving an access certificate that is further based on the user's participation in a particular event.

4. The method of claim 1, wherein receiving the access certificate that authorizes the user to access the media content comprises receiving an access certificate that indicates a particular level of access to the media content that is granted to the user.

5. The method of claim 1, further comprising:
monitoring the user's presence within the zone; and
authorizing the user to receive the media content only if the user visits the zone at a minimum frequency.

6. The method of claim 1, further comprising:
monitoring the user's presence within the zone; and
authorizing the user to receive the media content only if the user visits the zone for a minimum amount of time.

7. The method of claim 1, further comprising identifying the user's presence in the zone with a positioning system.

8. The method of claim 1, further comprising identifying the user's presence in the zone based on an access point with which the communication device has established a communication link.

9. The method of claim 1, further comprising automatically communicating the access certificate to the communication device.

10. The method of claim 1, further comprising communicating the access certificate to the communication device in response to receiving a user request from the communication device.

11. A method of providing selective access to media content, comprising:
identifying at least one communication device within a particular zone; and
communicating an access certificate to the communication device, the access certificate indicating the particular zone and providing an authorization to access the media content.

12. The method of claim 11, wherein communicating the access certificate comprises communicating an access certificate that indicates a user's presence in the zone.

13. The method of claim 11, wherein communicating the access certificate comprises communicating an access certificate that indicates a user's presence in the zone at a particular time.

14. The method of claim 11, wherein communicating the access certificate comprises communicating an access certificate that indicates a user's participation in a particular event.

15. The method of claim 11, wherein communicating the access certificate comprises communicating an access certificate that indicates a particular level of access to the media content that is granted to the user.

16. A program storage device readable by a machine, tangibly embodying a program of instructions executable by the machine to perform method steps for providing selective access to media content, said method steps comprising:
for at least a user, receiving an access certificate that authorizes the user to access the media content based on the user's presence in a particular zone at a particular time;
determining whether the user is authorized to access the media content; and
providing to the user access to the media content when the user is authorized to access the media content.

17. The program storage device of claim 16, said method steps further comprising:
declining to the user access to the media content when the user is not authorized to access the media content.

18. The program storage device of claim 16, said method steps further comprising:
monitoring the user's presence within the zone; and
authorizing the user to receive the media content only if the user visits the zone at a minimum frequency.

19. The program storage device of claim 16, wherein receiving the access certificate that authorizes the user to access the media content comprises receiving an access certificate that is further based on the user's participation in a particular event.

20. The program storage device of claim 16, said method steps further comprising:
monitoring the user's presence within the zone; and
authorizing the user to receive the media content only if the user visits the zone for a minimum amount of time.
